(19) United States
(12) Patent Application Publication
(10) Pub. No.: US 2025/0383993 A1
(43) Pub. Date: Dec. 18, 2025

(54) PROCESSOR, INFORMATION PROCESSING APPARATUS, AND INFORMATION PROCESSING METHOD

(71) Applicant: Fujitsu Limited, Kawasaki-shi (JP)

(72) Inventor: YUKI KAMIKUBO, Yokohama (JP)

(73) Assignee: Fujitsu Limited, Kawasaki-shi (JP)

(21) Appl. No.: 19/228,102

(22) Filed: Jun. 4, 2025

(30) Foreign Application Priority Data
Jun. 12, 2024 (JP) 2024-095189

(51) Int. Cl. G06F 12/0811

(52) U.S. Cl. CPC G06F 12/0811; G06F 2212/6026

(57) ABSTRACT

In a processor, a control unit determines whether data to be read by a load instruction is present in a cache and processes the load instruction by making a data response by, on the basis of a determination result, using data stored in the cache or a memory, a linked list structure detection unit detects a first load instruction in which data having a linked list structure is taken as an object to be read, and a pre-acquisition control unit predicts that a first type of data to be read by the first load instruction detected by the linked list structure detection unit will not be present in the cache and causes the control unit to read the first type of data from the memory prior to processing of the first load instruction and to process the first load instruction by using the first type of data read previously.

### CROSS-REFERENCE TO RELATED APPLICATION

This application is based upon and claims the benefit of priority of the prior Japanese Patent Application No. 2024-095189, filed on Jun. 12, 2024, the entire contents of which are incorporated herein by reference.

### FIELD

The embodiments discussed herein are related to a processor, an information processing apparatus, and an information processing method.

### BACKGROUND

A computer includes a plurality of levels of cache memories between a CPU (central processing unit) core and a main storage device, and attempts to conceal latency of access to the main storage device or lower-level cache memories and improve throughput shortage. Further, these days, increases in the speed of the core and achievement of a many-core system in the CPU are in progress, and an improvement in the hit rate of the cache memory and concealment of cache miss latency are important.

As a method for improving the hit rate of the cache memory and concealing cache miss latency, introduction of a prefetch technique is being advanced. The prefetch technique is a technology in which data expected to be used in the near future is read into a cache memory in units of cache lines in advance and thereby the occurrence of cache misses is reduced. Methods for implementing prefetch include a software-based technique called software prefetch and a hardware-based technique called hardware prefetch.

The hardware prefetch is a data address prediction method typified by stream prefetch or stride prefetch, or the like, and mostly targets arrays of data arranged at regular addresses. In the case where there is regularity in addresses of data, an address to be prefetched can be easily found by following the rule; thus, in the case of a data address prediction method, an improvement in processing performance can be expected by hardware prefetch.

Further, as a technology of prefetch, a technology in which the order of memory addresses accessed in association with execution of a program is stored, data to be acquired is fetched from the memory to a cache in advance on the basis of the stored order, and the program is executed is proposed.

The related technology is described, for example, in Japanese Laid-open Patent Publication No. 2008-191824.

However, there are various types of data structures and the addresses do not necessarily have regularity in all structures, and there is a case where a linked list structure, which is a data structure in which each element has information of reference to the next element, is used. In the linked list structure, there is no regularity in addresses, and the next address is not settled unless a forward part of the list structure is loaded; therefore, an address prediction such as a data address prediction method is difficult. Thus, in the linked list structure, since an address prediction such as data address prediction is difficult, an improvement in performance by hardware prefetch has been difficult.

Further, in the case of memory access to data having a linked list structure, a cache miss is very highly likely to occur; thus, it is the case that latency is reduced by performing reading directly from the memory without checking each level of cache. However, this is merely a measure against the problem that there are many cache misses, and it is difficult to improve the processing performance of the arithmetic unit.

Further, in the technology of prefetching data on the basis of the order of accessed memory addresses, it is difficult to determine whether the data has a linked list structure or not, and the processing performance of the arithmetic unit may be reduced in the case of data having regularity in addresses.

### SUMMARY

According to an aspect of an embodiment, a processor includes a cache, a control unit, a linked list structure detection unit, and a pre-acquisition control unit. The control unit determines whether data to be read by a load instruction is present in the cache or not and processes the load instruction by making a data response by, on the basis of a determination result, using data stored in the cache or a memory. The linked list structure detection unit detects a first load instruction in which data having a linked list structure is taken as an object to be read. The pre-acquisition control unit predicts that a first type of data to be read by the first load instruction detected by the linked list structure detection unit will not be present in the cache and causes the control unit to read the first type of data from the memory prior to processing of the first load instruction and to process the first load instruction by using the first type of data read previously.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a processor according to an embodiment;

FIG. 2 is a diagram illustrating an example of a program including a load instruction that targets data having a linked list structure;

FIG. 3 is a diagram illustrating an example of a linked list structure detection table;

FIG. 4 is a diagram illustrating an example of a pre-acquisition queue according to a first embodiment;

FIG. 5 is a diagram illustrating a flow of acquisition of data from a memory in the case where pre-acquisition processing is not performed;

FIG. 6 is a diagram illustrating a flow of acquisition of data from a memory in the case where pre-acquisition processing is performed;

FIG. 7 is a flowchart of linked list structure detection processing by a processor according to the first embodiment;

FIG. 8 is a flowchart of data pre-acquisition processing by the processor according to the first embodiment;

FIG. 9 is a diagram illustrating an example of a pre-acquisition queue according to a second embodiment; and

FIG. 10 is a hardware configuration diagram of an information processing apparatus.

### DESCRIPTION OF EMBODIMENTS

Preferred embodiments of the present invention will be explained with reference to accompanying drawings. The processor, the information processing apparatus, and the information processing method disclosed by the present application are not limited by the following embodiments.

### [a] First Embodiment

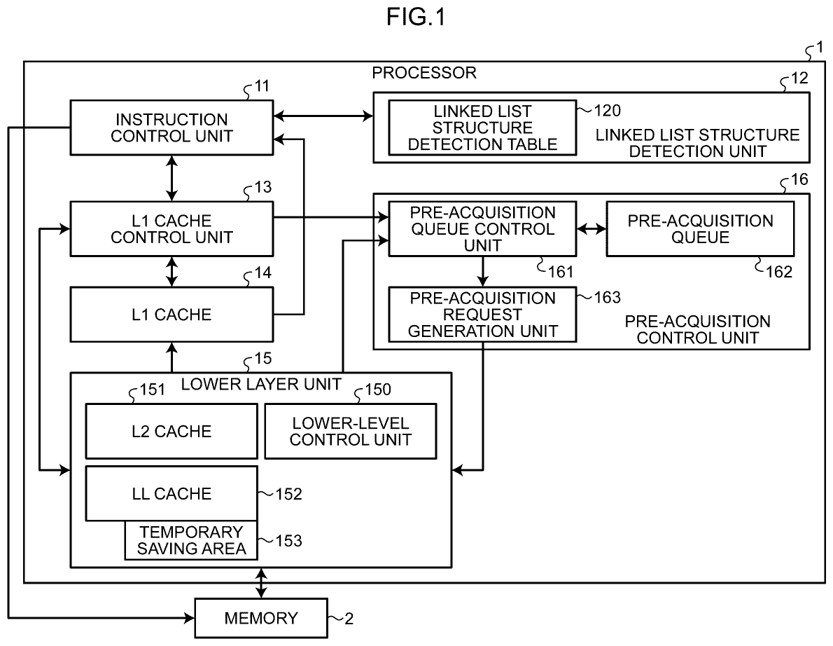

FIG. 1 is a block diagram of a processor according to an embodiment. A processor 1 is connected to a memory 2. The processor 1 executes a given instruction by using the memory 2. For example, in the case of a load instruction, the processor 1 reads data stored in the memory 2 from the memory 2, an L1 cache 14, or the like. Further, in the case of a write instruction, the processor 1 writes data on the memory 2. As illustrated in FIG. 1, the processor 1 includes an instruction control unit 11, a linked list structure detection unit 12, an L1 cache control unit 13, an L1 cache 14, a lower layer unit 15, and a pre-acquisition control unit 16.

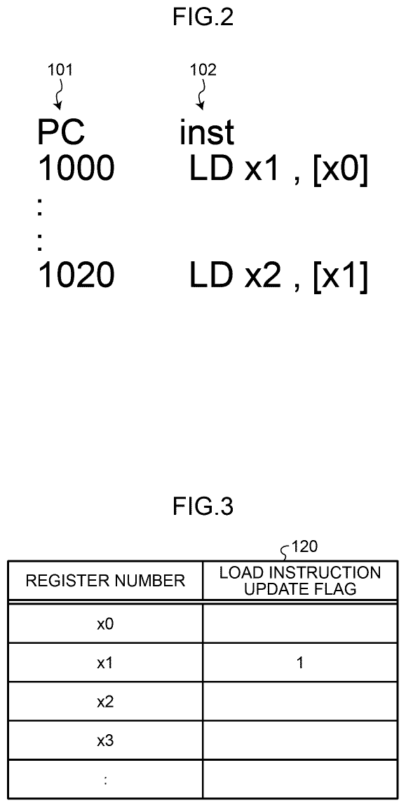

FIG. 2 is a diagram illustrating an example of a program including a load instruction that targets data having a linked list structure. Here, a program including a load instruction that targets data having a linked list structure will now be described with reference to FIG. 2.

Column 101 of FIG. 2 represents a program counter (PC), and column 102 represents an execution instruction. The program counter indicates, by the value it holds, an address where an instruction to be executed next is present. For example, at an address of number 1000 indicated by the program counter, there is an execution instruction of “LD x1, (x0)” (for the sake of writing, the form of parentheses is changed).

Here, the execution instruction represented by “LD xb, (xa)” (a and b are arbitrary numbers) is a load instruction that data stored in a location indicated by an address that is stored in a register having a register number of xa is to be stored into a location indicated by an address that is stored in a register having a register number of xb. Here, xa, which is the source of data reading, is called a source operand, and xb, which is the destination of data storage, is called a destination operand.

Although herein a load instruction is described, a source operand and a destination operand are designated also in a write instruction. Hereinafter, an address indicated by the value of a program counter is referred to as an address indicated by the program counter. Further, an instruction present at an address indicated by a program counter is referred to as an instruction of the address. For example, when the program counter indicates an address of number 1000, the instruction present at the address of number 1000 is referred to as an instruction of number 1000.

The instruction of number 1000 in FIG. 2 is a load instruction that data stored in a location indicated by an address that is stored in a register having a register number of x0 is to be stored into a location indicated by an address that is stored in a register having a register number of x1. The instruction of number 1020 is a load instruction that the data that has been stored in the register having a register number of x1 by the load instruction of number 1000 is to be stored into a register having a register number of x2.

Thus, in the program illustrated in FIG. 2, the register indicated by the pointer of the load instruction of number 1000 serves as the register of the source of data reading in the load instruction of number 1020. In other words, the destination operand of the load instruction of number 1000 serves as the source operand of the load instruction of number 1020. That is, the program illustrated in FIG. 2 includes a load instruction that targets data having a linked list structure.

Returning to FIG. 1, the description is continued. The instruction control unit 11 starts execution of a given program, and acquires an execution instruction designated in the program. Then, the instruction control unit 11 determines whether the acquired execution instruction is a memory access instruction or not. In the case where the execution instruction is not a memory access instruction, the instruction control unit 11 executes arithmetic processing or the like designated by the execution instruction.

In contrast, in the case where the execution instruction is a memory access instruction, the instruction control unit 11 executes the following memory access processing. The instruction control unit 11 notifies the linked list structure detection unit 12 of instruction information including the register numbers of the destination operand and the source operand designated by the execution instruction that is a memory access instruction, and the instruction type.

After that, when the execution instruction that is a memory access instruction is a load instruction, the instruction control unit 11 receives, from the linked list structure detection unit 12, load instruction superimposition information indicating whether the instruction that updated the register of the source operand of the load instruction is a load instruction or not. Next, the instruction control unit 11 issues the load instruction to the L1 cache control unit 13. Further, the instruction control unit 11 outputs the load instruction superimposition information and the value of the program counter of the load instruction to the L1 cache control unit 13. After that, the instruction control unit 11 acquires the data to be read of the load instruction from the L1 cache 14.

On other hand, in the case where the execution instruction that is a memory access instruction is not a load instruction but a write instruction, the instruction control unit 11 writes, on the memory 2, the data designated by the write instruction.

The linked list structure detection unit 12 includes a linked list structure detection table 120. FIG. 3 is a diagram illustrating an example of a linked list structure detection table. As illustrated in FIG. 3, the linked list structure detection table 120 is a table in which register numbers and a load instruction update flag corresponding to each register number are registered. The load instruction update flag is information indicating whether the register of the corresponding register number is set as the destination operand of another load instruction or not. Herein, when the value of the load instruction update flag is 1, it indicates that the corresponding register number is set as the destination operand of another load instruction. Here, although in FIG. 3 a load instruction update flag for which the value is not set to 1 is indicated as a blank, the linked list structure detection unit 12 may, for example, initialize the value of the load instruction update flag to 0.

The linked list structure detection unit 12 receives, from the instruction control unit 11, an input of instruction information including the register numbers of the destination operand and the source operand of an execution instruction, and the instruction type. Next, from the instruction type, the linked list structure detection unit 12 determines whether the execution instruction is a load instruction or not.

In the case where the execution instruction is a load instruction, the linked list structure detection unit 12 searches the linked list structure detection table 120, and specifies an entry corresponding to the register number of the destination operand of the execution instruction. Then, the linked list structure detection unit 12 updates the value of the load instruction update flag of the entry corresponding to the register number of the destination operand of the execution instruction to 1.

Next, the linked list structure detection unit 12 searches the linked list structure detection table 120 with the register number of the source operand of the execution instruction, and checks the value of the load instruction update flag of an entry corresponding to the register number of the source operand of the execution instruction. In the case where the value of the load instruction update flag is 1, the linked list structure detection unit 12 notifies the instruction control unit 11 of load instruction superimposition information indicating that the instruction that updated the register of the source operand of the load instruction is a load instruction.

In contrast, in the case where the value of the load instruction update flag is other than 1, the linked list structure detection unit 12 notifies the instruction control unit 11 of load instruction superimposition information indicating that the instruction that updated the register of the source operand of the load instruction is not a load instruction.

On the other hand, in the case where the execution instruction is not a load instruction, the linked list structure detection unit 12 searches the linked list structure detection table 120, and specifies an entry corresponding to the register number of the destination operand of the execution instruction. Then, the linked list structure detection unit 12 updates the value of the load instruction update flag of the entry corresponding to the register number of the destination operand of the execution instruction to 0. After that, in the case where the value of the load instruction update flag is other than 1, the linked list structure detection unit 12 notifies the instruction control unit 11 of load instruction superimposition information indicating that the instruction that updated the register of the source operand of the execution instruction is not a load instruction.

For example, in the case where, in a state where the linked list structure detection table 120 is in the state of FIG. 3, the load instruction of number 1020 in FIG. 2 is executed, the linked list structure detection unit 12 sets the value of the load instruction update flag of an entry having a register number of x2 to 1. Next, the linked list structure detection unit 12 checks the load instruction update flag of an entry having a register number of x1. Since the value of the load instruction update flag of the entry having a register number of x1 is 1, the linked list structure detection unit 12 notifies the instruction control unit 11 of load instruction superimposition information indicating that the instruction that updated the register of the source operand of the load instruction is a load instruction.

Thus, the linked list structure detection unit 12 detects a first load instruction in which data having a linked list structure is taken as an object to be read. In other words, a load instruction that is determined by the linked list structure detection unit 12 to be a load instruction in which data having a linked list structure is taken as an object to be read is an example of a “first load instruction”. For example, in the case where data to be read by a specific load instruction is data stored by another load instruction that was executed previously, the linked list structure detection unit 12 detects the specific load instruction as a first load instruction.

Returning to FIG. 1, the description is continued. The L1 cache control unit 13 receives an input of a load instruction issued from the instruction control unit 11. Further, the L1 cache control unit 13 receives, from the instruction control unit 11, an input of load instruction superimposition information and the value of the program counter of the load instruction.

Next, the L1 cache control unit 13 executes L1 cache miss determination regarding the data to be loaded designated by the load instruction. In the case where the data in question is present in the L1 cache 14, the L1 cache control unit 13 determines that this case is a cache hit. Then, the L1 cache control unit 13 transmits the data to be loaded designated by the load instruction from the L1 cache 14 to the instruction control unit 11, and thus makes a data response.

In contrast, in the case where the data in question is not present in the L1 cache 14, the L1 cache control unit 13 determines that this case is a cache miss. Then, the L1 cache control unit 13 makes, to the lower layer unit 15, a data request of the data to be loaded designated by the load instruction. Further, the L1 cache control unit 13 refers to the load instruction superimposition information, and checks whether the instruction that updated the register of the source operand of the load instruction to be processed is a load instruction or not.

When the instruction that updated the register of the source operand of the load instruction to be processed is not a load instruction, the L1 cache control unit 13 determines that the data targeted by the load instruction does not have a linked list structure. Then, without giving an instruction of data pre-acquisition processing of previously acquiring the designated data from the memory 2, the L1 cache control unit 13 makes, to the lower layer unit 15, a request of acquisition of the data designated by the load instruction, and waits for a data response from the lower layer unit 15.

After that, upon receiving a data response from the lower layer unit 15, the L1 cache control unit 13 transmits the data to be read of the load instruction from the L1 cache 14 to the instruction control unit 11, and thus makes a data response.

In contrast, when the instruction that updated the register of the source operand of the load instruction to be processed is a load instruction, the L1 cache control unit 13 determines that the data to be read of the load instruction has a linked list structure. Next, the L1 cache control unit 13 transmits the value of the program counter of the load instruction to the pre-acquisition control unit 16, and instructs the pre-acquisition control unit 16 to perform data pre-acquisition processing. Then, the L1 cache control unit 13 makes, to the lower layer unit 15, a request of acquisition of the data to be read of the load instruction, and waits for a data response from the lower layer unit 15. After that, upon receiving a data response from the lower layer unit 15, the L1 cache control unit 13 transmits the data to be read of the load instruction from the L1 cache 14 to the instruction control unit 11, and thus makes a data response.

The pre-acquisition control unit 16 includes a pre-acquisition queue control unit 161, a pre-acquisition queue 162, and a pre-acquisition request generation unit 163.

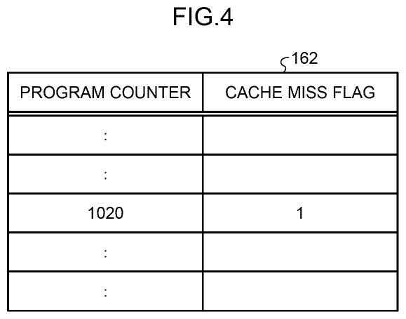

FIG. 4 is a diagram illustrating an example of a pre-acquisition queue according to the first embodiment. As illustrated in FIG. 4, the pre-acquisition queue 162 has a plurality of entries in each of which a program counter and a cache miss flag can be registered.

The pre-acquisition queue control unit 161 receives, from the L1 cache control unit 13, an instruction of data pre-acquisition processing together with the value of the program counter of the load instruction. Next, the pre-acquisition queue control unit 161 searches the pre-acquisition queue 162 with the communicated value of the program counter.

In the case where there is no entry of the communicated value of the program counter in the pre-acquisition queue 162, the pre-acquisition queue control unit 161 waits until L2 cache miss determination and LL cache miss determination in the lower layer unit 15 are performed. Then, the pre-acquisition queue control unit 161 receives, from the lower layer unit 15, an input of cache miss information indicating whether cache misses have occurred in both an L2 cache 151 and an LL cache 152 in the lower layer unit 15 or not. Hereinafter, a situation where cache misses occur in both the L2 cache 151 and the LL cache 152 in the lower layer unit 15 is referred to as a “lower-level cache miss”.

In the case where the pre-acquisition queue control unit 161 has acquired cache miss information indicating the occurrence of a lower-level cache miss, the pre-acquisition queue control unit 161 determines that the load instruction indicated by the program counter is a load instruction that has experienced a lower-level cache miss. That is, the pre-acquisition queue control unit 161 can determine that the load instruction indicated by the program counter is a load instruction that targets data having a linked list structure and that has experienced a lower-level cache miss.

In this case, the pre-acquisition queue control unit 161 registers the communicated value of the program counter in a new entry of the pre-acquisition queue 162, and sets 1 as a cache miss flag. Thereby, using the values of program counters, the pre-acquisition queue control unit 161 can perform training of load instructions that target data having a linked list structure and that experience lower-level cache misses.

Here, although in the present embodiment the pre-acquisition queue control unit 161 registers the communicated value of the program counter in a new entry in the case where cache miss information is sent from the lower layer unit 15, the pre-acquisition queue control unit 161 may perform registration into the pre-acquisition queue 162 by another procedure. For example, in the case where there is no entry of the communicated value of the program counter in the pre-acquisition queue 162, the pre-acquisition queue control unit 161 registers the value of the program counter in a new entry, and sets the cache miss flag to 0. Then, in the case where cache miss information indicating a lower-level cache miss is communicated in a data response, the pre-acquisition queue control unit 161 may update the cache miss flag of the entry of the value of the program counter to 1.

In the case where the pre-acquisition queue control unit 161 has acquired cache miss information indicating that a lower-level cache miss has not occurred, the pre-acquisition queue control unit 161 determines that the load instruction indicated by the program counter is a load instruction that has not experienced a lower-level cache miss. Then, the pre-acquisition queue control unit 161 registers the communicated value of the program counter in a new entry of the pre-acquisition queue 162, and updates the cache miss flag to 0.

On the other hand, in the case where there is an entry of the communicated value of the program counter in the pre-acquisition queue 162, the pre-acquisition queue control unit 161 checks the cache miss flag of the entry. When the cache miss flag is 1, the pre-acquisition queue control unit 161 determines that the load instruction is an instruction that targets data having a linked list structure and that experiences a lower-level cache miss. Then, the pre-acquisition queue control unit 161 notifies the pre-acquisition request generation unit 163 of the communicated value of the program counter, and instructs the pre-acquisition request generation unit 163 to make a pre-acquisition request. In contrast, when the cache miss flag is 0, the pre-acquisition queue control unit 161 ends the data pre-acquisition processing.

After that, the pre-acquisition queue control unit 161 waits until a data response from the lower layer unit 15 is sent to the L1 cache control unit 13. Then, the pre-acquisition queue control unit 161 receives an input of cache miss information from the lower layer unit 15. After that, the pre-acquisition queue control unit 161 updates the cache miss flag of the entry of the communicated value of the program counter in the pre-acquisition queue 162.

The pre-acquisition request generation unit 163 receives, from the pre-acquisition queue control unit 161, an instruction to make a pre-acquisition request. Next, the pre-acquisition request generation unit 163 generates a pre-acquisition request of acquisition from the memory 2 of the data to be read of the load instruction of the communicated address of the program counter. Then, the pre-acquisition request generation unit 163 outputs the generated pre-acquisition request to the lower layer unit 15.

Thus, the pre-acquisition control unit 16 predicts that a first type of data to be read by a first load instruction detected by the linked list structure detection unit 12 will not be present in the L2 cache 151 or the LL cache 152. Then, the pre-acquisition control unit 16 causes a lower-level control unit 150 to read the first type of data from the memory 2 prior to the processing of the first load instruction, and to process the first load instruction by using the first type of data read previously. The cache miss flag of the pre-acquisition queue 162 is an example of information indicating “a detection result communicated from the lower-level control unit 150”. That is, on the basis of a detection result communicated from the lower-level control unit 150, the pre-acquisition control unit 16 predicts that a first type of data will not be present in the L2 cache 151 or the LL cache 152.

In the present embodiment, the lower layer unit 15 includes a lower-level control unit 150, an L (layer) 2 cache 151, and an LL (last level) cache 152. However, the cache layers of the lower layer unit 15 are not limited thereto.

The L2 cache 151 is a cache of the next layer after the L1 cache 14. The LL cache 152 is a cache of the next layer after the L2 cache 151, and is the last cache. The LL cache 152 has, in addition to an area for caching data, a temporary saving area 153 for temporarily storing data. Each of the L2 cache 151 and the LL cache 152 is an example of a “cache”.

The lower-level control unit 150 controls reading of data from the L2 cache 151 and the LL cache 152, and writing of data on the L2 cache 151 and the LL cache 152.

The lower-level control unit 150 receives a pre-acquisition request from the pre-acquisition request generation unit 163. Next, the lower-level control unit 150 makes, to the memory 2, a request of acquisition of the data designated by the pre-acquisition request. After that, the lower-level control unit 150 acquires the data designated by the pre-acquisition request from the memory 2, and then the lower-level control unit 150 stores the pre-acquired data into the temporary saving area 153 of the LL cache 152.

Further, the lower-level control unit 150 receives, from the L1 cache control unit 13, a request of acquisition of the data to be read of the load instruction. Next, the lower-level control unit 150 executes L2 cache miss determination regarding the data to be loaded designated by the load instruction.

In the case where the data in question is present in the L2 cache 151, the lower-level control unit 150 determines that this case is a cache hit. Then, the lower-level control unit 150 outputs, to the pre-acquisition queue control unit 161, cache miss information indicating a cache hit in the lower layer unit 15. Next, the lower-level control unit 150 transmits, to the L1 cache 14, the data to be loaded that is the object to be read of the load instruction which is present in the L2 cache 151, and makes, to the L1 cache control unit 13, a data response that communicates storage of the data in question into the L1 cache 14.

In contrast, in the case where the data in question is not present in the L2 cache 151, the lower-level control unit 150 determines that this case is a cache miss. Next, the lower-level control unit 150 executes LL cache miss determination regarding the data to be read of the load instruction.

In the case where the data in question is present in the LL cache 152, the lower-level control unit 150 determines that this case is a cache hit. Then, the lower-level control unit 150 outputs, to the pre-acquisition queue control unit 161, cache miss information indicating a cache hit in the lower layer unit 15. Next, the lower-level control unit 150 transmits, to the L1 cache 14 via the L2 cache 151, the data to be read of the load instruction present in the LL cache 152. Then, the lower-level control unit 150 makes, to the L1 cache control unit 13, a data response that communicates storage of the data in question into the L1 cache 14.

In contrast, in the case where the data in question is not present in the LL cache 152, the lower-level control unit 150 determines that this case is a cache miss. Then, the lower-level control unit 150 outputs, to the pre-acquisition queue control unit 161, cache miss information indicating the occurrence of a lower-level cache miss.

Next, the lower-level control unit 150 determines whether the data to be read of the load instruction is stored in the temporary saving area 153 of the LL cache 152 or not. Here, when the load instruction is a load instruction that targets data having a linked list structure and that has experienced a cache miss in the lower layer unit 15, the data designated by the load instruction is stored in the temporary saving area 153.

In the case where the data to be read of the load instruction is stored in the temporary saving area 153 of the LL cache 152, the lower-level control unit 150 acquires the data in question from the temporary saving area 153, and transmits the data to the L1 cache 14 via the LL cache 152 and the L2 cache 151. Then, the lower-level control unit 150 makes, to the L1 cache control unit 13, a data response that communicates storage of the data in question into the L1 cache 14.

In contrast, when the data to be read of the load instruction is not stored in the temporary saving area 153 of the LL cache 152, the lower-level control unit 150 makes, the memory 2, a request of acquisition of the data to be read of the load instruction. After that, the lower-level control unit 150 acquires the data to be read of the load instruction from the memory 2. Next, the lower-level control unit 150 transmits the data acquired from the memory 2 to the L1 cache 14 via the LL cache 152 and the L2 cache 151, and makes a data response to the L1 cache control unit 13.

The lower-level control unit 150 is an example of a “control unit”. That is, the lower-level control unit 150 determines whether data to be read by a load instruction is present in either the L2 cache 151 or the LL cache 152, or neither of them, and processes the load instruction by making a data response by, on the basis of the determination result, using data stored in the L2 cache 151 or the LL cache 152, or the memory 2. Further, the lower-level control unit 150 transmits cache miss information to the pre-acquisition control unit 16, and thereby notifies the pre-acquisition control unit 16 of a detection result obtained by detecting in advance that a first type of data is not present in either the L2 cache 151 or the LL cache 152.

Here, although in the present embodiment pre-acquired data is stored in the temporary saving area 153 and is used for subsequent processing of a load instruction, the lower-level control unit 150 can put data pre-acquired from the memory 2 directly into the LL cache 152 without temporarily saving the data. In this case, the lower-level control unit 150 preferably performs control so as to maintain cache coherence in the LL cache 152.

With regard to the memory 2, upon receiving a data write instruction from the instruction control unit 11, the memory 2 writes data on a designated address. Further, upon receiving a data acquisition request from the lower-level control unit 150, the memory 2 reads designated data, and outputs the data to the lower-level control unit 150.

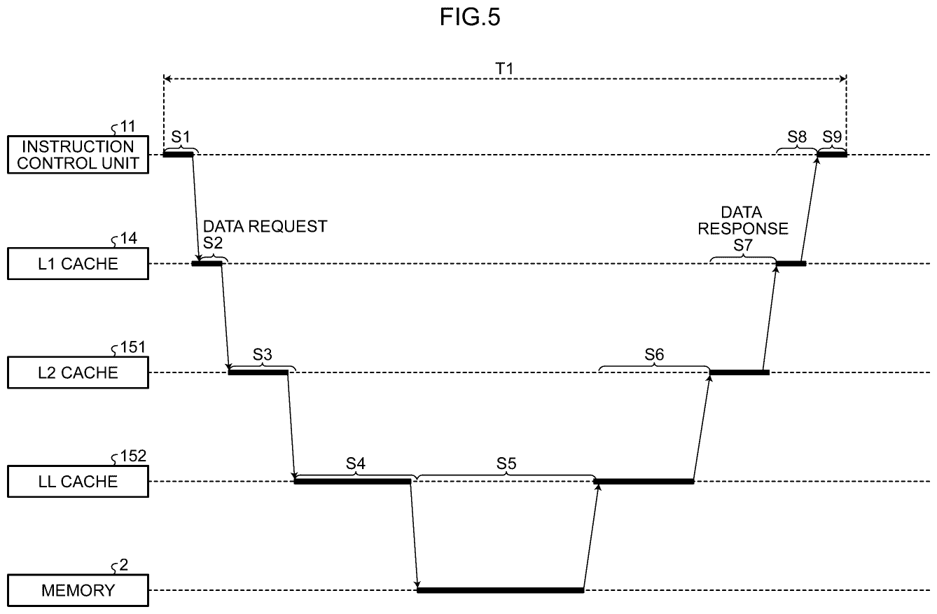

FIG. 5 is a diagram illustrating a flow of acquisition of data from the memory in the case where pre-acquisition processing is not performed. A flow of acquisition of data from the memory 2 in the case where pre-acquisition processing is not performed will now be described with reference to FIG. 5.

The instruction control unit 11 issues a data request according to a load instruction (step S1).

Next, L1 cache miss determination is performed by the L1 cache control unit 13; in the case where the data in question is not present in the L1 cache 14, a data request is made to the lower layer unit 15 (step S2).

Next, L2 cache miss determination is performed by the lower-level control unit 150; in the case where the data in question is not present in the L2 cache 151, a data request to the LL cache 152 is made (step S3).

Next, LL cache miss determination is performed by the lower-level control unit 150; in the case where the data in question is not present in the LL cache 152, a data acquisition request to the memory 2 is made (step S4).

The memory 2 reads the data in question according to the data acquisition request, and transmits the data to the LL cache 152 (step S5).

The data sent from the memory 2 is stored in the LL cache 152, and then the data in question is sent to the L2 cache 151 (step S6).

Next, the data sent from the LL cache 152 is stored in the L2 cache 151, and then the data in question is sent to the L1 cache 14 (step S7).

Next, the data sent from the L2 cache 151 is stored in the L1 cache 14, and then a data response of transmitting the data in question is sent to the instruction control unit 11 by the L1 cache control unit 13 (step S8).

The instruction control unit 11 acquires the data sent from the L1 cache 14, and completes the execution of the load instruction (step S9).

Here, in the case where pre-acquisition processing is not performed, the time it takes from the issuance of the load instruction to the completion of execution of the load instruction by the instruction control unit 11 is time T1.

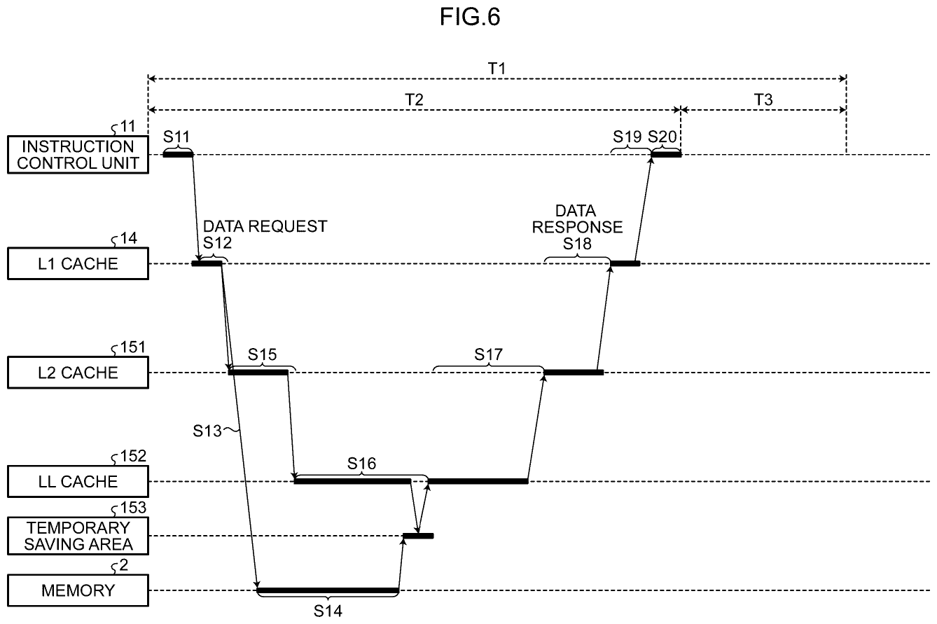

FIG. 6 is a diagram illustrating a flow of acquisition of data from the memory in the case where pre-acquisition processing is performed. A flow of acquisition of data from the memory 2 in the case where pre-acquisition processing is performed will now be described with reference to FIG. 6.

The instruction control unit 11 issues a data request according to a load instruction (step S11).

Next, L1 cache miss determination is performed by the L1 cache control unit 13; in the case where the data in question is not present in the L1 cache 14, a data request is made to the lower layer unit 15 (step S12).

At this time, in the case where a cache miss occurs in the L1 cache 14 and the target data of the load instruction has a linked list structure, the pre-acquisition control unit 16 receives an instruction of pre-acquisition processing from the L1 cache control unit 13. Then, when the cache miss flag of the entry of the value of the program counter indicating the load instruction in the pre-acquisition queue 162 is 1, the pre-acquisition control unit 16 makes a request to the memory 2 of acquisition of the data in question (step S13).

The memory 2 reads the data in question according to the data acquisition request from the pre-acquisition control unit 16, and transmits the data to the lower layer unit 15. The data sent from the memory 2 is stored in the temporary saving area 153 (step S14).

In parallel with the pre-acquisition processing by the pre-acquisition control unit 16, L2 cache miss determination is performed by the lower-level control unit 150; in the case where the data in question is not present in the L2 cache 151, a data request to the LL cache 152 is made (step S15).

Next, the lower-level control unit 150 performs LL cache miss determination; in the case where the data in question is not present in the LL cache 152, the lower-level control unit 150 reads the data in question stored in the temporary saving area 153 (step S16).

Next, the data read from the temporary saving area 153 is stored in the LL cache 152, and then the data in question is sent to the L2 cache 151 (step S17).

Next, the data sent from the LL cache 152 is stored in the L2 cache 151, and then the data in question is sent to the L1 cache 14 (step S18).

Next, the data sent from the L2 cache 151 is stored in the L1 cache 14, and then a data response of transmitting the data in question is sent to the instruction control unit 11 by the L1 cache control unit 13 (step S19).

The instruction control unit 11 acquires the data sent from the L1 cache 14, and ends the execution of the load instruction (step S20).

Here, in the case where pre-acquisition processing is performed, the time it takes from the issuance of the load instruction to the completion of execution of the load instruction by the instruction control unit 11 is time T2. That is, the processing time of a load instruction for data having a linked list structure can be shortened by time T3 that is the difference between time T1 and time T2. Time T3 is approximately the time it takes for the lower layer unit 15 to acquire data from the memory 2; by performing pre-acquisition processing, the time it takes for the lower layer unit 15 to acquire data from the memory 2 can be concealed.

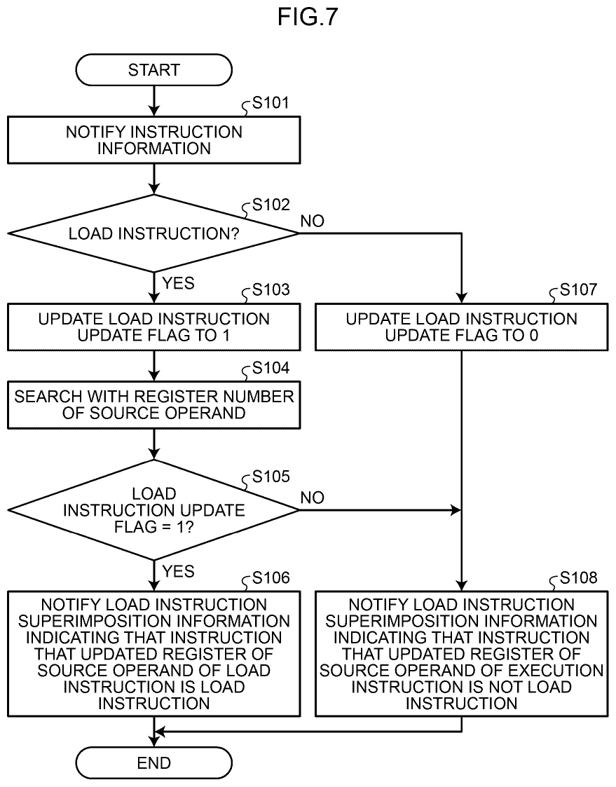

FIG. 7 is a flowchart of linked list structure detection processing by the processor according to the first embodiment. Next, a flow of linked list structure detection processing by the processor 1 according to the embodiment is described with reference to FIG. 7.

The instruction control unit 11 starts execution of a given program, and acquires an execution instruction designated in the program. Then, in the case where the execution instruction is a memory access instruction, the instruction control unit 11 notifies the linked list structure detection unit 12 of instruction information including the register numbers of the destination operand and the source operand, and the instruction type (step S101).

The linked list structure detection unit 12 receives an input of instruction information from the instruction control unit 11. Next, from the instruction type included in the instruction information, the linked list structure detection unit 12 determines whether the execution instruction is a load instruction or not (step S102).

In the case where the execution instruction is a load instruction (step S102: Yes), the linked list structure detection unit 12 searches the linked list structure detection table 120, and specifies an entry corresponding to the register number of the destination operand of the execution instruction. Then, the linked list structure detection unit 12 updates the value of the load instruction update flag of the entry corresponding to the register number of the destination operand of the execution instruction to 1 (step S103).

Next, the linked list structure detection unit 12 searches the linked list structure detection table 120 with the register number of the source operand of the execution instruction (step S104).

Then, the linked list structure detection unit 12 determines whether the value of the load instruction update flag of the entry corresponding to the register number of the source operand of the execution instruction is 1 or not (step S105).

In the case where the value of the load instruction update flag is 1 (step S105: Yes), the linked list structure detection unit 12 notifies the instruction control unit 11 of load instruction superimposition information indicating that the instruction that updated the register of the source operand of the load instruction is a load instruction (step S106).

In contrast, in the case where the value of the load instruction update flag is 0 (step S105: No), the linked list structure detection unit 12 notifies the instruction control unit 11 of load instruction superimposition information indicating that the instruction that updated the register of the source operand of the execution instruction is not a load instruction (step S108).

On the other hand, in the case where the execution instruction is not a load instruction (step S102: No), the linked list structure detection unit 12 searches the linked list structure detection table 120, and specifies an entry corresponding to the register number of the destination operand of the execution instruction. Then, the linked list structure detection unit 12 updates the value of the load instruction update flag of the entry corresponding to the register number of the destination operand of the execution instruction to 0 (step S107). After that, the linked list structure detection unit 12 notifies the instruction control unit 11 of load instruction superimposition information indicating that the instruction that updated the register of the source operand of the execution instruction is not a load instruction (step S108).

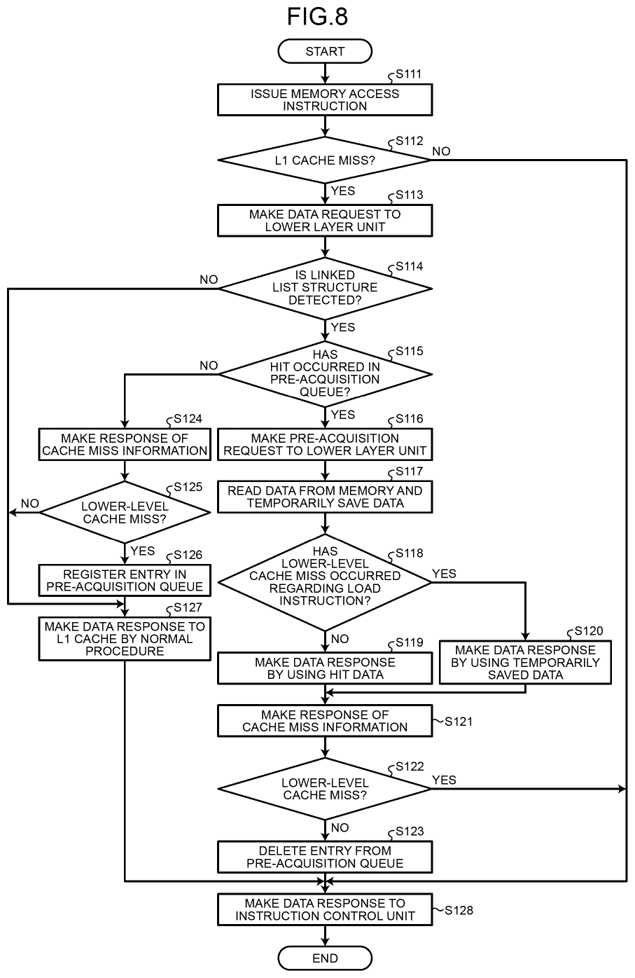

FIG. 8 is a flowchart of data pre-acquisition processing by the processor according to the first embodiment. Next, a flow of data pre-acquisition processing by the processor 1 according to the embodiment is described with reference to FIG. 8.

The instruction control unit 11 receives load instruction superimposition information from the linked list structure detection unit 12. Next, the instruction control unit 11 issues, to the L1 cache control unit 13, a memory access instruction that is a load instruction (step S111). Further, the instruction control unit 11 outputs the load instruction superimposition information and the value of the program counter of the load instruction to the L1 cache control unit 13.

The L1 cache control unit 13 receives an input of a load instruction issued from the instruction control unit 11. Further, the L1 cache control unit 13 receives an input of load instruction superimposition information from the instruction control unit 11. Next, the L1 cache control unit 13 determines whether a cache miss has occurred in the L1 cache 14 regarding the data to be read of the load instruction or not (step S112). In the case where a cache hit has occurred (step S112: No), the data pre-acquisition processing proceeds to step S128.

On the other hand, in the case where a cache miss has occurred (step S112: Yes), the L1 cache control unit 13 makes, to the lower layer unit 15, a data request of the data to be read of the load instruction (step S113).

Further, the L1 cache control unit 13 refers to the load instruction superimposition information, and determines whether a linked list structure is detected as a data structure of the data targeted by the load instruction or not (step S114).

In the case where a linked list structure is not detected (step S114: No), the data pre-acquisition processing proceeds to step S127.

In contrast, in the case where a linked list structure is detected (step S114: Yes), the L1 cache control unit 13 transmits the value of the program counter of the load instruction to the pre-acquisition queue control unit 161, and instructs the pre-acquisition queue control unit 161 to execute data pre-acquisition processing. The pre-acquisition queue control unit 161 searches the pre-acquisition queue 162 with the communicated value of the program counter, and determines whether a hit occurs or not (step S115).

In the case where the search result is a hit (step S115: Yes), the pre-acquisition queue control unit 161 notifies the pre-acquisition request generation unit 163 of the communicated value of the program counter, and instructs the pre-acquisition request generation unit 163 to make a pre-acquisition request. The pre-acquisition request generation unit 163 generates a pre-acquisition request of acquisition from the memory 2 of the data to be read of the load instruction of the communicated address of the program counter, and outputs the pre-acquisition request to the lower layer unit 15; thus, the pre-acquisition request generation unit 163 makes a data pre-acquisition request (step S116).

Upon receiving the pre-acquisition request from the pre-acquisition request generation unit 163, the lower-level control unit 150 reads the data designated by the pre-acquisition request from the memory 2, and temporarily saves the pre-acquired data in the temporary saving area 153 of the LL cache 152 (step S117).

In parallel with the pre-acquisition request, the lower-level control unit 150 receives, from the L1 cache control unit 13, a request of acquisition of the data to be read of the load instruction. Then, the lower-level control unit 150 sequentially determines whether the data in question is hit in the L2 cache 151 or hit in the LL cache 152, and determines whether a lower-level cache miss has occurred regarding the load instruction or not (step S118).

In the case where a lower-level cache miss does not occur (step S118: No), the lower-level control unit 150 makes a data response to the L1 cache control unit 13 by using the data hit in the L2 cache 151 or the LL cache 152 (step S119).

On the other hand, in the case where a lower-level cache miss has occurred (step S118: Yes), the lower-level control unit 150 makes a data response to the L1 cache control unit 13 regarding the load instruction by using the data temporarily saved in the temporary saving area 153 (step S120).

Further, the lower-level control unit 150 makes a response of cache miss information to the pre-acquisition queue control unit 161 (step S121).

The pre-acquisition queue control unit 161 investigates the cache miss information that is a response from the lower-level control unit 150, and determines whether a lower-level cache miss has occurred or not (step S122). In the case where a lower-level cache miss has occurred (step S122: Yes), the data pre-acquisition processing proceeds to step S128.

In contrast, in the case where a lower-level cache miss has not occurred (step S122: No), the pre-acquisition queue control unit 161 deletes, from the pre-acquisition queue 162, the entry of the value of the program counter indicating the load instruction (step S123). After that, the data pre-acquisition processing proceeds to step S128.

On the other hand, in the case where the search result is not a hit (step S115: No), the pre-acquisition queue control unit 161 receives, from the lower-level control unit 150, a response of cache miss information (step S124).

Then, the pre-acquisition queue control unit 161 investigates the cache miss information that is a response from the lower-level control unit 150, and determines whether a lower-level cache miss has occurred or not (step S125). In the case where a lower-level cache miss has not occurred (step S125: No), the data pre-acquisition processing proceeds to step S127.

In contrast, in the case where a lower-level cache miss has occurred (step S125: Yes), the pre-acquisition queue control unit 161 registers, in the pre-acquisition queue 162, an entry of the value of the program counter indicating the load instruction (step S126). At this time, the pre-acquisition queue control unit 161 sets the cache miss flag to 1. After that, the data pre-acquisition processing proceeds to step S127.

The lower-level control unit 150 acquires the data to be read of the load instruction by a normal procedure using the L2 cache 151, the LL cache 152, and the memory 2, and makes a data response to the L1 cache control unit 13 by using the acquired data (step S127). After that, the data pre-acquisition processing proceeds to step S128.

After that, the L1 cache control unit 13 transmits the data to be read of the load instruction from the L1 cache 14 to the instruction control unit 11, and thus makes a data response (step S128).

As described hereinabove, in the case where a load instruction is issued, the processor according to the present embodiment determines whether the load instruction targets data having a linked list structure or not by using a linked list structure detection table. In the case where the load instruction targets data having a linked list structure, the processor according to the present embodiment uses a pre-acquisition queue to determine whether the load instruction is a load instruction that has experienced a lower-level cache miss or not. In the case where the load instruction is an instruction that targets data having a linked list structure and that has experienced a lower-level cache miss, the processor according to the present embodiment performs pre-acquisition of data from the memory. When processing the load instruction, the processor according to the present embodiment makes a data response by using the data read by pre-acquisition.

Thereby, in the case of a load instruction for data having a linked list structure in which a cache miss is very highly likely to occur, reading is performed directly from the memory without checking lower-level caches, and thus latency can be reduced. Therefore, the performance of processing data having a linked list structure can be improved.

Here, the data pre-acquisition processing described in the embodiment provides higher effects when the cache hierarchy is deeper, but can be applied also to shallower cache hierarchies. For example, the data pre-acquisition processing can be applied even in the case where the number of cache layers is one.

### [b] Second Embodiment

Next, a second embodiment is described. A processor according to the present embodiment performs control such that data pre-acquisition processing is executed preferentially on a load instruction having high probability of a lower-level cache miss. Also the processor according to the present embodiment is illustrated by the block diagram of FIG. 1. In the following description, a description of operations of each unit similar to those of the first embodiment is omitted.

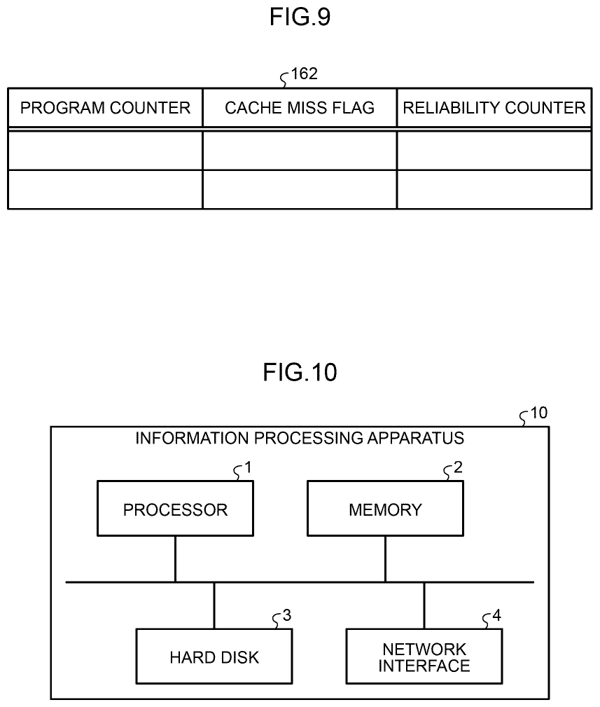

FIG. 9 is a diagram illustrating an example of a pre-acquisition queue according to the second embodiment. In each entry of a pre-acquisition queue 162 according to the present embodiment, a program counter, a cache miss flag, and a reliability counter can be registered. As a reliability counter, the number of responses of cache miss information indicating that a lower-level cache miss has occurred is registered.

The pre-acquisition queue control unit 161 receives, from the L1 cache control unit 13, an instruction of data pre-acquisition processing together with the value of the program counter of the load instruction. Next, the pre-acquisition queue control unit 161 searches the pre-acquisition queue 162 with the communicated value of the program counter.

In the case where there is no entry of the communicated value of the program counter in the pre-acquisition queue 162, the pre-acquisition queue control unit 161 waits until L2 cache miss determination and LL performed. Then, the pre-acquisition queue control unit cache miss determination in the lower layer unit 15 are 161 receives an input of cache miss information from the lower layer unit 15.

In the case where the pre-acquisition queue control unit 161 has acquired cache miss information indicating the occurrence of a lower-level cache miss, the pre-acquisition queue control unit 161 registers the communicated value of the program counter in a new entry of the pre-acquisition queue 162, and updates the cache miss flag to 1. Further, the pre-acquisition queue control unit 161 sets 1 as a reliability counter.

In the case where the pre-acquisition queue control unit 161 has acquired cache miss information indicating that a lower-level cache miss has not occurred, the pre-acquisition queue control unit 161 registers the communicated value of the program counter in a new entry of the pre-acquisition queue 162, and sets the cache miss flag to 0.

On the other hand, in the case where there is an entry of the communicated value of the program counter in the pre-acquisition queue 162, the pre-acquisition queue control unit 161 checks the cache miss flag of the entry. When the cache miss flag is 1, the pre-acquisition queue control unit 161 notifies the pre-acquisition request generation unit 163 of the communicated value of the program counter, and instructs the pre-acquisition request generation unit 163 to make a pre-acquisition request. In contrast, when the cache miss flag is 0, the pre-acquisition queue control unit 161 ends the data pre-acquisition processing.

After that, the pre-acquisition queue control unit 161 waits until cache miss information is sent from the lower layer unit 15. Then, the pre-acquisition queue control unit 161 receives an input of cache miss information from the lower layer unit 15. In the case of cache miss information indicating that a lower-level cache miss has occurred, the pre-acquisition queue control unit 161 increments the reliability counter of the entry of the communicated value of the program counter in the pre-acquisition queue 162 by one.

In contrast, in the case of cache miss information indicating that a lower-level cache miss has not occurred, the pre-acquisition queue control unit 161 acquires the reliability counter of the entry of the communicated value of the program counter in the pre-acquisition queue 162. Then, the pre-acquisition queue control unit 161 compares a predetermined threshold and the value of the reliability counter.

When the value of the reliability counter is equal to or greater than the threshold, the pre-acquisition queue control unit 161 leaves the entry in the pre-acquisition queue 162. In contrast, when the value of the reliability counter is less than the threshold, the pre-acquisition queue control unit 161 deletes the entry from the pre-acquisition queue 162.

Thus, by leaving, in the pre-acquisition queue 162, an entry in which the value of the reliability counter is equal to or greater than a threshold, the pre-acquisition control unit 16 detects, as a first load instruction, a load instruction in which the probability of non-presence in either the L2 cache 151 or the LL cache 152 is equal to or greater than a threshold.

As described hereinabove, the pre-acquisition queue control unit according to the present embodiment counts up the reliability counter according to the occurrence of a lower-level cache miss, and in the case where a lower-level cache miss has not occurred, deletes an entry in which the reliability counter is less than a threshold from the pre-acquisition queue. Thereby, entries related to load instructions having high probability of occurrence of a cache miss remain in the pre-acquisition queue, and data pre-acquisition processing can be executed on a load instruction having high probability of occurrence of a cache miss. Therefore, data pre-acquisition processing can be efficiently performed, and the performance of processing data having a linked list structure can be improved.

### Hardware Configuration

FIG. 10 is a hardware configuration diagram of an information processing apparatus. The processor 1 according to the embodiment is mounted on, for example, an information processing apparatus 10 illustrated in FIG. 10.

The information processing apparatus 10 includes a processor 1, a memory 2, a hard disk 3, and a network interface 4. The processor 1 is connected to the memory 2, the hard disk 3, and the network interface 4 via a bus.

The hard disk 3 is an auxiliary storage device, and stores various programs including an OS (operating system) and the like. The network interface 4 is a communication interface between the information processing apparatus 10 and an external device.

The processor 1 reads a program from the hard disk 3, develops the program in the memory 2, and executes the program. When executing the program read from the hard disk 3, the processor 1 implements the functions of the instruction control unit 11, the linked list structure detection unit 12, the L1 cache control unit 13, the L1 cache 14, the lower layer unit 15, and the pre-acquisition control unit 16.

In an aspect, the present invention can improve processing performance.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A processor comprising:
a cache;
a control unit that determines whether data to be read by a load instruction is present in the cache or not and processes the load instruction by making a data response by, on the basis of a determination result, using data stored in the cache or a memory;
a linked list structure detection unit that detects a first load instruction in which data having a linked list structure is taken as an object to be read; and
a pre-acquisition control unit that predicts that a first type of data to be read by the first load instruction detected by the linked list structure detection unit will not be present in the cache and causes the control unit to read the first type of data from the memory prior to processing of the first load instruction and to process the first load instruction by using the first type of data read previously.

2. The processor according to claim 1, wherein, in a case where data to be read by a specific load instruction is data stored by another load instruction that was executed previously, the linked list structure detection unit detects the specific load instruction as the first load instruction.

3. The processor according to claim 1, wherein
the control unit detects in advance that the first type of data is not present in the cache and notifies the pre-acquisition control unit of a detection result, and
the pre-acquisition control unit, on the basis of the detection result communicated from the control unit, predicts that the first type of data will not be present in the cache.

4. The processor according to claim 1, wherein the pre-acquisition control unit detects, as a first load instruction, a load instruction in which probability of non-presence in the cache is equal to or greater than a threshold.

5. An information processing apparatus comprising:
a processor; and a memory,
the processor including:
a cache;
a control unit that determines whether data to be read by a load instruction is present in the cache or not and processes the load instruction by making a data response by, on the basis of a determination result, using data stored in the cache or the memory;
a linked list structure detection unit that detects a first load instruction in which data having a linked list structure is taken as an object to be read; and
a pre-acquisition control unit that predicts that a first type of data to be read by the first load instruction detected by the linked list structure detection unit will not be present in the cache and causes the control unit to read the first type of data from the memory prior to processing of the first load instruction and to process the first load instruction by using the first type of data read previously.

6. An information processing method comprising:
by a processor including a cache, executing processing of:
issuing load instructions;
determining whether data to be read by an issued load instruction is present in the cache or not and processing the load instruction by making a data response by, on the basis of a determination result, using data stored in the cache or a memory;
detecting, among the issued load instructions, a first load instruction in which data having a linked list structure is taken as an object to be read;
predicting that a first type of data to be read by the detected first load instruction will not be present in the cache;
reading the first type of data from the memory prior to processing of the first load instruction; and
processing the first load instruction by using the first type of data read previously.
